(19) United States
(12) Patent Application Publication
(10) Pub. No.: US 2016/0164129 A1
(43) Pub. Date: Jun. 9, 2016

(54) ELECTRODE FOR FUEL CELLS

(71) Applicants: TOYOTA JIDOSHA KABUSHIKI KAISHA, Toyota-shi (JP); KYOTO UNIVERSITY, Kyoto-shi (JP)

(72) Inventors: Kazuki AMEMIYA, Minami-Aips-shi (JP); Takuro MATSUNAGA, Nagakute-shi (JP); Masashi HARADA, Nagakute-shi (JP); Akihiro SHINOHARA, Nagakute-shi (JP); Naoki HASEGAWA, Nagakute-shi (JP); Masaaki SUGIYAMA, lzumi-shi (JP); Yojiro OBA, Sennan-gun (JP); Nobuhiro SATO, lzumisano-shi (JP)

(73) Assignees: TOYOTA JIDOSHA KABUSHIKI KAISHA, Toyota-shi (JP); KYOTO UNIVERSITY, Kyoto-shi (JP)

(21) Appl. No.: 14/954,455

(22) Filed: Nov. 30, 2015

(30) Foreign Application Priority Data
Dec. 3, 2014 (JP) 2014-244989

(51) Int. Cl. H01M 8/10

(52) U.S. Cl. CPC H01M 8/1004; H01M 8/1023; H01M 8/1039; H01M 2008/1095; H01M 2300/0082

(57) ABSTRACT

The present invention is to provide a high-performance electrode for fuel cells. Disclosed is an electrode for polymer electrolyte fuel cells, comprising a polymer electrolyte material and a metal catalyst carried on carbon, wherein the polymer electrolyte material is an electrolyte material represented by the following general formula:

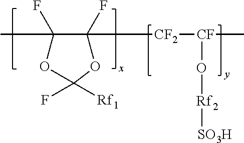

and wherein, in a graph showing a relationship between a scattering vector magnitude and a scattering intensity, both of which are obtained by measuring the electrode in an air atmosphere by a smaller-angle neutron scattering method, the electrode has such a hydrophilic domain dispersibility that the maximum value of ratios of scattering intensities to baseline intensities for all ion peaks is in a range of more than 1.00 to 1.42.

### BACKGROUND OF THE INVENTION

1. Technical Field

The present invention relates to an electrode for fuel cells.

2. Background Art

The electrode of a polymer electrolyte fuel cell generally contains a catalyst-carried carbon and a polymer electrolyte. The electrode functions as a membrane electrode assembly (MEA) in combination with an electrolyte membrane. From the latest findings, it has been found that to increase the performance of a polymer electrolyte fuel cell, it is particularly important to increase the gas permeability of the polymer electrolyte in the electrode of the fuel cell.

A polymer electrolyte material used for the electrode and electrolyte membrane of a polymer electrolyte fuel cell is an amphiphilic polymer compound having hydrophilic and hydrophobic parts, and it is considered that the hydrophilic parts function as a channel which is necessary for ion conduction, and the hydrophobic parts function to let gases (such as oxygen and hydrogen) pass therethrough and supply them to reaction sites.

An electrolyte membrane is disclosed in Patent Literature 1, having such a structure that hydrophilic domains, which are self-assembled hydrophilic parts, and hydrophobic domains, which are self-assembled hydrophobic parts, are highly phase-separated by using a polymer electrolyte which is likely to self-assemble. In the polymer electrolyte having the highly phase-separated structure, proton conducting paths formed by the hydrophilic domains are continuous and contribute to the high proton conductivity of the electrolyte membrane.

Patent Literature 1: Japanese Patent Application Laid-Open No. 2008-311226

However, electrode performance can be decreased when the polymer electrolyte is excessively phase-separated in the electrode. This is considered to be because the continuously present hydrophilic domains inhibit gas permeation.

### SUMMARY OF THE INVENTION

The present invention was achieved in light of the above circumstances. An object of the present invention is to provide an electrode for polymer electrolyte fuel cells, in which the hydrophilic domains are in a more highly dispersed state than prior art electrodes.

The electrode for polymer electrolyte fuel cells according to the present invention comprises a polymer electrolyte material and a metal catalyst carried on carbon, wherein the polymer electrolyte material is an electrolyte material represented by the following general formula (1), and wherein, in a graph showing a relationship between a scattering vector magnitude (q) and a scattering intensity (I), both of which are obtained by measuring the electrode in an air atmosphere by a smaller-angle neutron scattering method, and defining a scattering intensity and a baseline intensity, both of which appear when the q value is in a range of 1 to 3 nm⁻¹, as (I_{spectrum}) and (I_{baseline}) respectively, the electrode has such a hydrophilic domain dispersibility that a maximum value of ratios of scattering intensities to baseline intensities (I_{spectrum}/I_{baseline}) for all q values is in a range of more than 1.00 to 1.42:

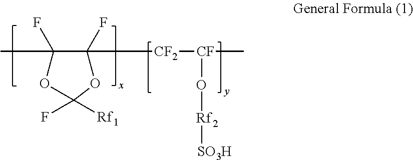

wherein Rf₁ is a perfluoroalkyl group having 1 to 10 carbon atoms, and the perfluoroalkyl group may have an oxygen atom in a molecular chain thereof; Rf₂ is —(CF₂CF(CF₃)O)ₕ—(CF₂)ᵢ-in which h is an integer of 0 to 3 and i is an integer of 1 to 10; x and y are each independently 1 or more, and x/y is 0.63 to 4.2; and an average molecular weight is 5,000 to 300,000.

According to the present invention, a high-performance electrode for polymer electrolyte fuel cells, in which hydrophilic domains are highly dispersed, can be provided by mixing a metal catalyst carried on carbon with such a polymer electrolyte material that a 5-membered ring unit that is asymmetric and less likely to self assemble is introduced therein.

### BRIEF DESCRIPTION OF DRAWINGS

FIG. 1 is a graph showing a relationship between the scattering vector magnitude (q) and the scattering intensity (I) which are obtained by measuring the electrode of Example 1 by smaller-angle neutron scattering.

FIGS. 2A and 2B are graphs each showing a relationship between the scattering vector magnitude (q) and the scattering intensity (I) which are obtained by measuring the electrode of Comparative Example 1 by smaller-angle neutron scattering.

FIG. 3-shows the cell performances of fuel cells produced by using the electrodes of Example 1 and Comparative Examples 1 and 2.

FIG. 4 shows a relationship between the maximum (I_{spectrum}/I_{baseline}) values of the electrodes of Example 1 and Comparative Examples 1 and 2 and the cell performances of the cells produced by using the electrodes.

### DETAILED DESCRIPTION OF THE INVENTION

Hereinafter, the electrode for fuel cells according to the present invention will be described.

The electrode for polymer electrolyte fuel cells according to the present invention contains a polymer electrolyte material and a metal catalyst carried on carbon, wherein the polymer electrolyte material is an electrolyte material represented by the following general formula (1), and wherein, in a graph showing a relationship between a scattering vector magnitude (q) and a scattering intensity (I), both of which are obtained by measuring the electrode in an air atmosphere by a smaller-angle neutron scattering method, and defining a scattering intensity and a baseline intensity, both of which appear when the q value is in a range of 1 to 3 nm^{-, as (I}_{spectrum}) and (I_{baseline}), respectively, the electrode has such a hydrophilic domain dispersibility that a maximum value of ratios of scattering intensities to baseline intensities (I_{spectrum}/I_{baseline}) for all q values is in a range of more than 1.00 to 1.42:

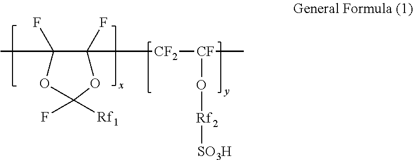

wherein Rf₁ is a perfluoroalkyl group having 1 to 10 carbon atoms, and the perfluoroalkyl group may have an oxygen atom in a molecular chain thereof; Rf₂ is —(CF₂CF(CF₃)O)ₕ—(CF₂)ᵢ-in which h is an integer of 0 to 3 and i is an integer of 1 to 10; x and y are each independently 1 or more, and x/y is 0.63 to 4.2; and an average molecular weight is 5,000 to 300,000.

The inventors of the present invention have found the following: even if an electrode is produced by using the polymer electrolyte material of the general formula (1), fuel cell performance varies depending on the type of the metal catalyst-carried carbon which is used in combination with the electrode, and the cell performance highly correlates with the results of the above-mentioned smaller-angle neutron scattering measurement of the electrode.

The results of the above-mentioned smaller-angle neutron scattering measurement of the electrode correlate with the dispersion state of the hydrophilic domains. Therefore, it is considered that gas diffusion performance increases as the hydrophilic domains become more highly dispersed, so that fuel cell performance is increased.

As shown by the general formula (1), the polymer electrolyte material used in the present invention has such a structure that a perfluoro monomer having an asymmetric 5-membered ring structure in the main chain-forming part and a perfluoro monomer having a pendant structure that is composed of a perfluoro group having a sulfonic acid group which serves as a hydrophilic part, are polymerized in a desired arrangement sequence.

Due to having the bulk and asymmetric 5-membered ring (1,3-dioxol ring) structure in the main chain, the polymer electrolyte material is resistant to crystallization. Therefore, phase separation is less likely to occur between the hydrophilic domains and the hydrophobic domains, and the dispersibility of the hydrophilic domains increases.

Rf₁ is a perfluoroalkyl group in the 2-position of the 1,3-dioxol ring, and the perfluoroalkyl group may have an oxygen atom in a molecular chain thereof. That is, the perfluoroalkyl group as Rf₁ may contain an oxygen atom that forms an ether bond between carbon atoms. As the carbon number of Rf₁ increases, the asymmetry of Rf₁ increases and the phase separation of the polymer electrolyte material is less likely to occur. However, when the carbon number of Rf₁ is too large, the equivalence weight (EW) of the polymer electrolyte material increases and the proton conductivity thereof decreases. Therefore, the carbon number of Rf₁ is 1 or more and 10 or less, preferably 2 or more and 5 or less.

Rf₂ is —(CF₂CF(CF₃)O)ₕ—(CF₂)ᵢ-in which h is an integer of 0 to 3 and i is an integer of 1 to 10.

As h (the number of repeated —(CF₂CF(CF₃)O)—) increases, the glass transition temperature, viscoelasticity, gas permeability or proton conductivity of the polymer electrolyte decreases. When h is too large, it is difficult to synthesize a monomer for forming a hydrophilic structure. Therefore, h is an integer of 0 to 3, preferably an integer of 0 to 1.

Due to the same reason as h, i (the number of repeated —(CF₂)—) is also an integer of 1 to 10, more preferably an integer of 2 to 5.

In the general formula (1), x and y are each independently 1 or more. In general, as x increases, gas permeability increases and proton conductivity decreases. Meanwhile, as y increases, gas permeability decreases and proton conductivity increases. Therefore, x/y is 0.63 to 4.2, more preferably 0.63 to 3.0.

In general, as the average molecular weight of the polymer electrolyte material increases, the solubility thereof decreases. On the other hand, as the average molecular weight of the polymer electrolyte material decreases, the fragility thereof increases. Therefore, the average molecular weight of the polymer electrolyte material is 5,000 to 300,000, preferably 10,000 to 100,000.

In the present invention, the metal catalyst carried on carbon is used, in which a metal that serves as a catalyst for electrochemical reactions is carried on an electroconductive carbon carrier.

In general, an expensive noble metal is used for the metal catalyst, such as platinum. The present invention makes it possible to increase the performance of electrodes. By making it possible to increase the performance of electrodes, the present invention also makes it possible to maintain electrode performance even when the amount of the noble metal used (such as platinum) is decreased.

Generally, in an electrode for polymer electrolyte fuel cells, an oxygen reduction reaction proceeds slowly and becomes a rate-limiting reaction. Accordingly, it is often the case that cathode is required to have high performance, and anode is required to decrease the amount of the noble metal used, such as platinum. Therefore, in the case of cathode, it is preferable to use the present invention in order to increase electrode performance. In the case of anode, it is preferable to use the present invention in order to decrease the amount of platinum used.

In general, carbon black, graphite, carbon nanotubes, carbon nanofibers, oxides, etc., are used as the carbon carrier.

The mixed state of the hydrophilic and hydrophobic parts in the polymer electrolyte is affected by an interaction between the carbon carrier surface and the polymer electrolyte material represented by the general formula (1). The polymer electrolyte represented by the general formula (1), which is less likely to form hydrophilic domains by itself, is far less likely to form hydrophilic domains when the polymer electrolyte coexists with the carbon carrier. Especially, a carbon A which was used in the below-described Example 1 and Comparative Example 1 is preferable because it has a specific surface area of about 200 m²/g and a hydrophobic surface, so that it potently inhibits the formation of hydrophilic domains.

In the present invention, the mixing ratio (I/C) of the polymer electrolyte (I) represented by the general formula (1) to the metal catalyst-carried carbon (C) is preferably in a range of 0.7 to 1.1, because a highly active electrode can be obtained.

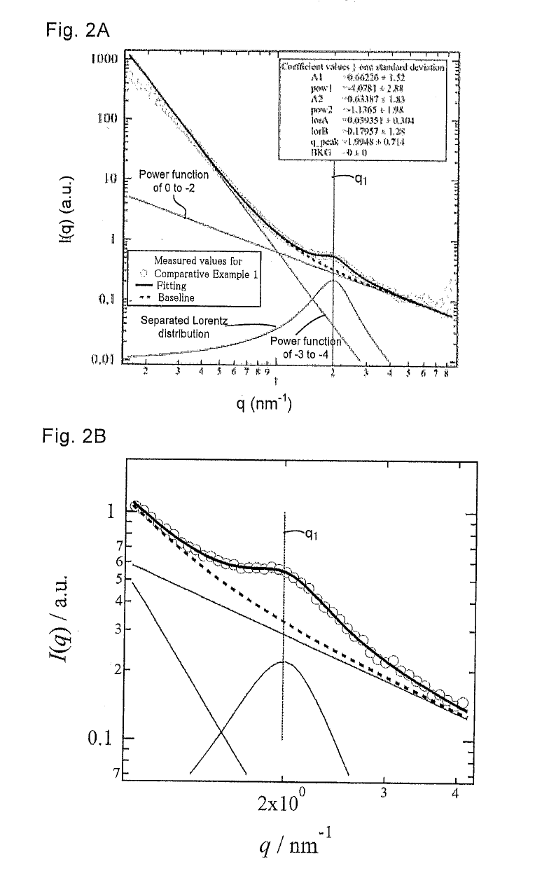

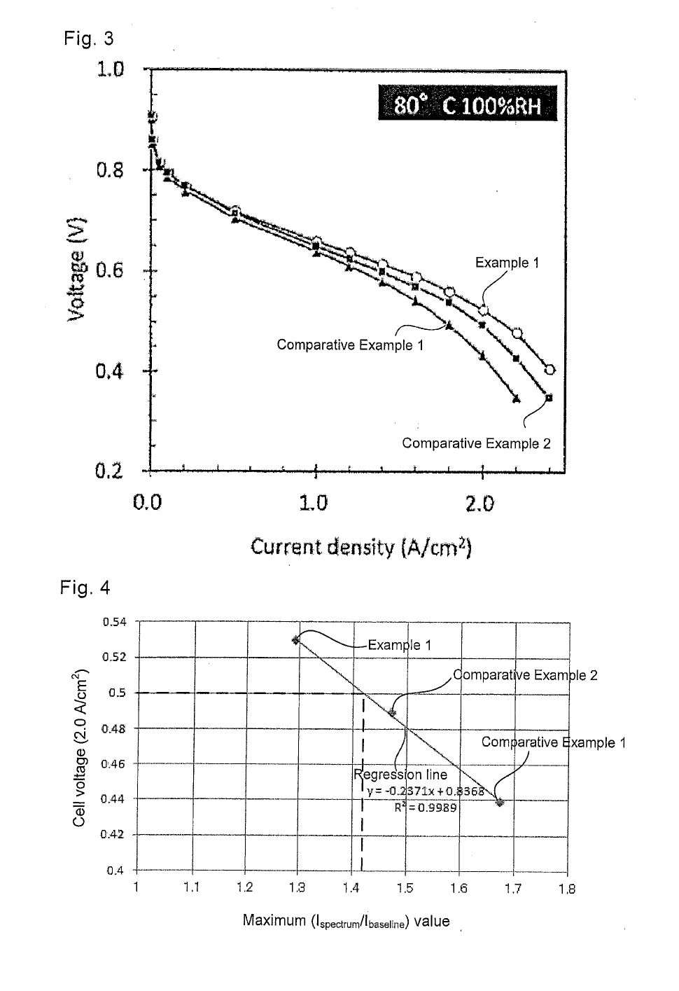

Next, the graph showing a relationship between a scattering vector magnitude (q) and a scattering intensity (I), both of which are obtained by measuring the electrode for polymer electrolyte fuel cells in an air atmosphere by a smaller-angle neutron scattering method, will be described with reference to FIGS. 2A and 2B.

As used herein, measuring the electrode in an air atmosphere means that the smaller-angle neutron scattering method is carried out in a gas such as air, not in a liquid.

The smaller-angle neutron scattering (SANS) is such a technique to identify the structural properties and so on of a sample (substance) by irradiating the sample (substance) with neutrons and observing the interference phenomenon of the waves of scattered neutrons.

FIGS. 2A and 2B show the scattering curves of electrode samples measured in an air atmosphere. In FIGS. 2A and 2B, the horizontal axis indicates the scattering vector magnitude q (nm⁻¹) and the vertical axis indicates scattering intensity I(q) (cm⁻¹). The scattering vector magnitude q on the horizontal axis can be expressed by the following equation (1) where 2θ is a scattering angle that is an angle between the wave vector of incident neutrons and that of scattered neutrons, and λ is the wavelength of the neutron beam.

q=4πsin θ/λ Equation (1)

The wavelength λ of the neutron beam is constant, so that the scattering vector magnitude q depends on the scattering angle 2θ.

As shown in FIG. 2A, when measured in an air atmosphere, an ion peak derived from the polymer electrolyte in the electrode is observed when the scattering vector magnitude q is in a range of 1 to 3 nm⁻¹. FIG. 2B is an enlarged figure of the ion peak.

The intensity of the ion peak correlates with the dispersibility of the hydrophilic domains self-assembled from the hydrophilic parts of the electrolyte. It is indicated that as the intensity decreases, the dispersion of the hydrophilic domains proceeds; moreover, as the intensity increases, the formation of the continuous hydrophilic domains proceeds.

As for the relationship with electrode performance, it is considered as follows: as the intensity of the ion peak decreases, the hydrophilic domains, which inhibit gas permeation, is more dispersed; therefore, such an electrode is a high-performance electrode with excellent gas permeability.

In the case where a scattering intensity and a baseline intensity, both of which appear when q is in a range of 1 to 3 nm⁻, are defined as I_{spectrum} and I_{baseline}, respectively, the intensity of the ion peak can be quantitatively expressed as the maximum value of ratios of scattering intensities to baseline intensities (I_{spectrum}/I_{baseline}) for all q values.

The baseline intensity can be obtained from a value synthesized from a power function with an exponent of −3 to −4 and a power function with an exponent of 0 to −2.

The maximum (I_{spectrum}/I_{baseline}) value can be directly obtained by dividing the measured scattering intensity value by the baseline intensity. Also, the maximum (I_{spectrum}/I_{baseline}) value can be obtained by carrying out a spectrum fitting using the sum of the power function with an exponent of −3 to −4, the power function with an exponent of 0 to −2, and the Lorentz function, and then interpolating the resulting data.

More specifically, from the resulting fitting data, the baseline data obtained by synthesizing the power function with an exponent of −3 to −4 and the power function with an exponent of 0 to −2 is removed, thereby obtaining the Lorentz distribution; the maximum value q₁ is obtained from the Lorentz distribution; and the scattering intensity at the interpolated q₁ is obtained from the fitting data, and the scattering intensity at the interpolated q₁ is obtained from the baseline data, thereby obtaining the maximum (I_{spectrum}/I_{baseline}) value.

The electrode of the present invention is such an electrode that the maximum (I_{spectrum}/I_{baseline}) value is more than 1.00 and 1.42 or less. In such an electrode, the hydrophilic domains are highly dispersed, so that the electrode shows higher performance than prior art electrodes. For example, in the case of prior art electrodes, when the electrode area is set to 13 cm², they cannot maintain a voltage of 0.5 V or more at a current density of 2.0 A/cm². In contrast, fuel cells using the electrode of the present invention can maintain a voltage of 0.5 V or more even at the current density of 2.0 A/cm².

### EXAMPLES

Hereinafter, the present invention will be described in more detail, by way of an example and comparative examples. The scope of the present invention is not limited to the following examples.

### Example 1

1. Preparation of catalyst ink

Carbon A, which is a metal catalyst-carried carbon for electrodes and has a specific surface area of about 200 m²/g and a hydrophobic surface, and a polymer electrolyte material of the following formula (2) were mixed with a dispersion solvent so that the mass ratio of the carbon A to the polymer electrolyte material was 1 to 1 (I/C=1) and the total of the mass of the carbon A and that of the polymer electrolyte material accounted for 3.0% of the total volume of the catalyst ink. The mixed solution was dispersed at 300 rpm for 3 hours using a planetary bead mill (“PM200” manufactured by Retsch), thereby obtaining a catalyst ink.

The polymer electrolyte material of the formula (2) is a concrete example of the polymer electrolyte material of the general formula (1).

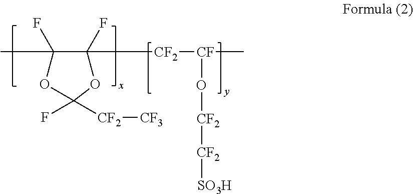

In the formula (2), x is 2.2, and y is 1.0. The average molecular weight of the polymer electrolyte material of the formula (2) is 4.0×10⁴.

### 2. Production of Electrode

An electrode was produced by spraying the above-prepared catalyst ink on a Teflon substrate so that the Pt mass per unit area of the electrode was 0.1 mg/cm², followed by drying the sprayed ink. The electrode thus produced was placed on a cathode side and thermally transferred to an electrolyte membrane (trade name: Nafion) at 150° C., thereby producing an MEA for the evaluation of the electrode. In a SANS measurement, an electrode produced by spraying the catalyst ink on an aluminum substrate in the same condition as above was used.

### Comparative Example 1

The preparation of the catalyst ink and the production of the electrode were carried out in the same manner as Example 1, except that the polymer electrolyte material of the formula (2) was changed to a perfluorosulfonic acid-based polymer (trade name: Nafion) of the following formula (3):

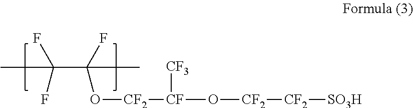

### Comparative Example 2

The preparation of the catalyst ink and the production of the electrode were carried out in the same manner as Example 1, except that the carbon A (a metal catalyst-carried carbon having a specific surface area of about 200 m²/g and a hydrophobic surface) was changed to a carbon B having a specific surface area of about 800 m²/g and a hydrophilic surface.

### <SANS Measurement>

Smaller-angle neutron scattering (SANS) measurement was carried out using the smaller-angle neutron scattering instrument “TAIKAN” at the high intensity proton accelerator facility “J-PARC”, and a continuous neutron beam with a wavelength A of 0.07 to 0.76 (nm) removed from a 300 kW experimental reactor, with a camera length (the distance between the sample and the transmission monitor of the device) of about 5.9 m.

The electrodes for the SANS measurement were encapsulated in quarts cells and measured in an air atmosphere.

### <Evaluation of Electrodes>

The MEAs produced in Example 1 and Comparative Examples 1 and 2 were embedded in fuel cells and subjected to an electrode performance evaluation test. Evaluation was carried out in the following conditions:

Electrode area: 13 cm²

Hydrogen electrode: hydrogen gas (1.0 L/min)

Air electrode: air (2.0 mL/min)

Gas outlet pressure at both electrodes: 150 kPa-abs

Temperature: 80° C.

Humidity: 100% RH

### (Results)

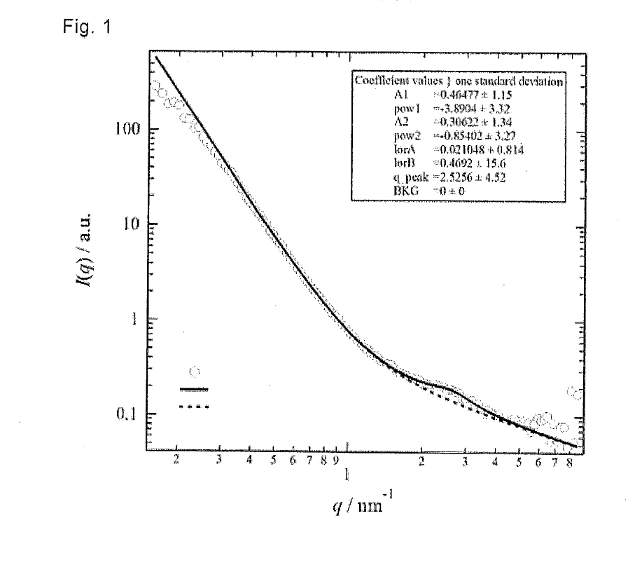

As examples, the smaller-angle neutron scattering spectrum of the electrode produced in Example 1 is shown in FIG. 1, and that of the electrode produced in Comparative Example 1 is shown in FIGS. 2A and 2B.

As for all of the electrodes of Example 1 and Comparative Examples 1 and 2, an ion peak derived from the hydrophilic domains contained in the electrodes is detected when the scattering vector magnitude q is in a range of 1 to 3 nm⁻¹. The magnitude increases in the order of Example 1 (smallest) <Comparative Example 2<Comparative Example 1 (largest).

Table 1 shows the maximum (I_{spectrum}/I_{baseline}) values and the electrode performance evaluation results of Example 1 and Comparative Examples 1 and 2.

As described above, the maximum (I_{spectrum}/I_{baseline}) value of each of the electrodes of Example 1 and Comparative Examples 1 and 2 was obtained as follows: from the spectrum fitting data obtained from the sum of the power function with an exponent of −3 to −4, the power function with an exponent of 0 to −2 and the Lorentz function, the baseline data obtained by synthesizing the power function with an exponent of −3 to −4 and the power function with an exponent of 0 to −2 was removed, thereby obtaining the Lorentz distribution; the maximum value q₁ was obtained from the Lorentz distribution; and the scattering intensity at the interpolated q₁ was obtained from the fitting data, and the scattering intensity at the interpolated q₁ was obtained from the baseline data, thereby obtaining the maximum (I_{spectrum}/I_{baseline}) value.

TABLE 1

| | | Metal | | |
|---|---|---|---|---|
| | Polymer | catalyst- | Maximum | Unit cell |
| | electrolyte | carried | (I_{spectrum}/I_{baseline}) | voltage |
| | material | carbon | value | (2.0 A/cm²) |
| Example 1 | Formula (2) | Carbon A | 1.29 | 0.53 |
| Comparative | Formula (3) | Carbon A | 1.67 | 0.44 |
| Example 1 | | | | |
| Comparative | Formula (2) | Carbon B | 1.47 | 0.49 |
| Example 2 | | | | |

As for Example 1, the maximum (I_{spectrum}/I_{baseline}) value is 1.29. This value is smaller than the value of Comparative Example 2 (1.47) and the value of Comparative Example 1 (1.67).

As for the electrodes of Example 1 and Comparative Example 2 in which the ionomer being represented by the formula (2) and having a rigid asymmetric 5-membered ring structure is used as the electrolyte, it is clear that the hydrophilic domains are more dispersed than the electrode of Comparative Example 1 in which the ionomer being represented by the formula (3) and having a flexible tetrafluoroethylene chain is used. Even in the case of using the same polymer electrolyte material (the polymer electrolyte material of the formula (2)), as for Example 1 in which the carbon A having a specific surface area of about 200 m²/g and a hydrophobic surface is used as the carbon carrier, it is clear that the hydrophilic domains are more dispersed than the electrode of Comparative Example 2 in which the carbon B having a specific surface area of about 800 m²/g and a hydrophilic surface is used. This is considered because, due to an interaction between the polymer electrolyte and the surface of the carbon A, which is hydrophobic and has a specific surface area of about 200 m²/g, the mixed state of the hydrophilic parts and the hydrophobic parts in the polymer electrolyte was changed, so that the hydrophilic domains self-assembled from the hydrophilic parts were not easily formed.

The results of Table 1 are graphed in FIG. 4. The graph shown in FIG. 4 is a graph with cell performance on the y-axis and the maximum (I_{spectrum}/I_{baseline}) value on the x-axis. Regression analysis was carried out based on the plots of Comparative Examples 1 and 2 and Example 1. As a result, a regression line which is represented by the following equation (2) and shows such a high correlation that the correlation coefficient (r²) is as high as 0.9989, was obtained.

y=−0.2371x+0.8368 Equation (2)

As described above, in the case of prior art electrodes, when the electrode area is set to 13 cm², they cannot maintain a voltage of 0.5 V or more at a current density of 2.0 A/cm². If this 0.5 V is plugged in for y of the regression line, the maximum (I_{spectrum}/I_{baseline}) value is 1.42. That is, such an electrode that the maximum (I_{spectrum}/I_{baseline}) value is 1.42 or less can maintain a voltage of 0.5 V or more, so that the electrode can be said to show higher performance compared to prior art electrodes.

When the maximum (I_{spectrum}/I_{baseline}) value is 1.00, the electrode loses its proton conductivity and cannot be used as an electrode. However, it is considered that as the maximum (I_{spectrum}/I_{baseline}) value decreases, the electrode becomes a higher-performance electrode with better gas permeability. Therefore, it is considered possible to extrapolate the regression line in a range that is quite close to 1.00.

From the above results, it is clear that the present invention can provide a high-performance electrode for polymer electrolyte fuel cells, which has such a hydrophilic domain dispersibility that the maximum (I_{spectrum}/I_{baseline}) value is more than 1.00 and 1.42 or less.

1. An electrode for polymer electrolyte fuel cells, comprising a polymer electrolyte material and a metal catalyst carried on carbon,
wherein the polymer electrolyte material is an electrolyte material represented by the following general formula (1), and
wherein, in a graph showing a relationship between a scattering vector magnitude and a scattering intensity, both of which are obtained by measuring the electrode in an air atmosphere by a smaller-angle neutron scattering method, and defining a scattering intensity and a baseline intensity, both of which appear when the q value is in a range of 1 to 3 nm⁻¹, as (I_{spectrum}) and (I_{baseline}), respectively, the electrode has such a hydrophilic domain dispersibility that a maximum value of ratios of scattering intensities to baseline intensities for all q values is in a range of more than 1.00 to 1.42: 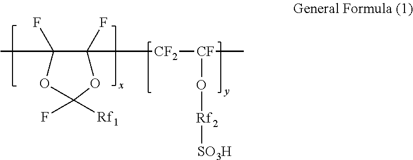
wherein Rf₁ is a perfluoroalkyl group having 1 to 10 carbon atoms, and the perfluoroalkyl group may have an oxygen atom in a molecular chain thereof; Rf₂ is —(CF₂CF(CF₃)O)ₕ—(CF₂)ᵢ— in which h is an integer of 0 to 3 and i is an integer of 1 to 10; x and y are each independently an integer of 1 or more, and x/y is 0.63 to 4.2; and an average molecular weight is 5,000 to 300,000.
